(19) United States
(12) Patent Application Publication
(10) Pub. No.: US 2024/0302813 A1
(43) Pub. Date: Sep. 12, 2024

(54) DISPLAY DEVICE

(71) Applicant: FANUC CORPORATION, Yamanashi (JP)

(72) Inventors: Tomoyuki AIZAWA, Yamanashi (JP); Junichi TEZUKA, Yamanashi (JP); Satoshi IKAI, Yamanashi (JP)

(73) Assignee: FANUC CORPORATION, Yamanashi (JP)

(21) Appl. No.: 18/260,463

(22) PCT Filed: Jan. 7, 2022
(86) PCT No.: PCT/JP2022/000337

§ 371 Date: Jul. 5, 2023

(30) Foreign Application Priority Data
Jan. 12, 2021 (JP) 2021-003055

(51) Int. Cl. G05B 19/404; G05B 19/402; G05B 19/4062

(52) U.S. Cl. CPC G05B 19/404; G05B 19/402; G05B 19/4062; G05B 2219/35349

(57) ABSTRACT

Provided is a display device that can automatically identify and display a vibration site and a vibration axis using empty processing. The present invention is a display device 1 that comprises: a trajectory error calculation unit 13 that, on the basis of a movement trajectory of a tool based on actual positions and a movement trajectory of the tool based on command positions, calculates time-sequence data of trajectory errors of the tool; an amplitude calculation unit 14 that calculates the amplitudes of frequency components by frequency analysis of the time-series data of the trajectory errors of the tool; a vibration detection unit 15 that detects a frequency component for which the amplitude of the frequency component exceeds a prescribed threshold value and detects a position corresponding to the detected frequency component as a vibration site; a vibration axis determination unit 16 that, by frequency analysis of time-sequence data of position deviations or torque commands of axes within a time range corresponding to the detected frequency component, determines an axis for which the amplitude of the frequency component identical to the detected frequency component is greatest to be a vibration axis; and a display unit 17 that displays the detected vibration site on the movement trajectory and displays the axis determined to be the vibration axis.

### TECHNICAL FIELD

The present disclosure relates to a display device.

### BACKGROUND ART

In machining by an industrial machine such as a machine tool, vibration is generated for various reasons. Since vibration causes machining defects such as the appearance of a line on a machined surface, detection and suppression of vibration are important to improve yield. The detection and evaluation of vibration locations are performed, for example, by the operator visually checking the machined surface of the workpiece that has been actually machined, but visual checks are greatly influenced by the operator's experience, making objective evaluation difficult.

In response, vibration locations are detected and evaluated by displaying and manipulating the position data and the like of axes acquired through actual machining. However, in this case, actual machining is required, and for such check using data, it is necessary to know in advance the vibration locations and to be familiar with the operation of the display device.

Accordingly, disclosed is a display device capable of allowing visual recognition of the correspondence between the position of the tool tip on the three-dimensional trajectory and the position of axes on the time axis in the time series waveform data (for example, see Patent Document 1). It is disclosed that, according to this display device, the movements of the axes corresponding to a point on the tool trajectory can be intuitively recognized, and the movements of the axes can be efficiently adjusted.
Patent Document 1: Japanese Unexamined Patent Application, Publication No. 2011-22688

### DISCLOSURE OF THE INVENTION

### Problems to be Solved by the Invention

However, in the display device of Patent Document 1, it is not possible to detect a vibration location on the movement trajectory of the tool and automatically identify a vibration axis that causes vibration at the vibration location. This is an important issue to be resolved because it directly leads to a decrease in the time efficiency of start-up and evaluation of industrial machines.

It is an object of the present disclosure to provide a display device capable of automatically identifying and displaying, in advance, a vibration location on a movement trajectory of a tool and a vibration axis that causes vibration, without actually performing machining in machining by an industrial machine.

### Means for Solving the Problems

(1) One aspect of the present disclosure is a display device for displaying servo data of a servo control device for controlling servo motors for driving axes of an industrial machine. The display device includes an acquisition unit, a movement trajectory calculation unit, a trajectory error calculation unit, an amplitude calculation unit, a vibration detection unit, a vibration axis determination unit, and a display unit. The acquisition unit is configured to acquire time series data of an actual position and time series data of a command position of each of the servo motors or driven bodies. The movement trajectory calculation unit is configured to calculate a movement trajectory of a tool based on the actual position and a movement trajectory of the tool based on the command position from the time series data of the actual position and the time series data of the command position of each of the servo motors or the driven bodies acquired by the acquisition unit. The trajectory error calculation unit is configured to calculate time-series data of a trajectory error of the tool from the movement trajectory of the tool based on the actual position and the movement trajectory of the tool based on the command position calculated by the movement trajectory calculation unit. The amplitude calculation unit is configured to perform frequency analysis of the time-series data of the trajectory error of the tool calculated by the trajectory error calculation unit, and calculate amplitudes of frequency components. The vibration detection unit is configured to detect, from among the frequency components, a frequency component having an amplitude calculated by the amplitude calculation unit that is greater than a predetermined threshold, and detect a position corresponding to the detected frequency component as a vibration location. The vibration axis determination unit is configured to extract a time range corresponding to the frequency component detected by the vibration detection unit, in the extracted time range, perform frequency analysis of time series data of a position deviation or a torque command of each of the axes, and determine, as a vibration axis, an axis having a frequency component having a great amplitude, the frequency component having the great amplitude being identical to the frequency component detected by the vibration detection unit. The display unit is configured to display the movement trajectory calculated by the movement trajectory calculation unit, display the vibration location detected by the vibration detection unit on the movement trajectory, and display the axis determined as the vibration axis by the vibration axis determination unit.

### Effects of the Invention

According to one aspect of the present disclosure, it is possible to provide a display device capable of automatically identifying and displaying, in advance, a vibration location on a movement trajectory of a tool and a vibration axis that causes vibration, without actually performing machining in machining by an industrial machine.

### BRIEF DESCRIPTION OF THE DRAWINGS

FIG. 1 shows a configuration of a display device according to an embodiment of the present disclosure;

FIG. 2 illustrates frequency analysis of time series data of a trajectory error of a tool;

FIG. 3 illustrates frequency analysis of time series data of position deviations of axes;

FIG. 4 shows a display example of the display device according to the embodiment; and

FIG. 5 is a flowchart showing a procedure of display processing by the display device according to the embodiment.

### PREFERRED MODE FOR CARRYING OUT THE INVENTION

An embodiment of the present disclosure will now be described in detail with reference to the drawings.

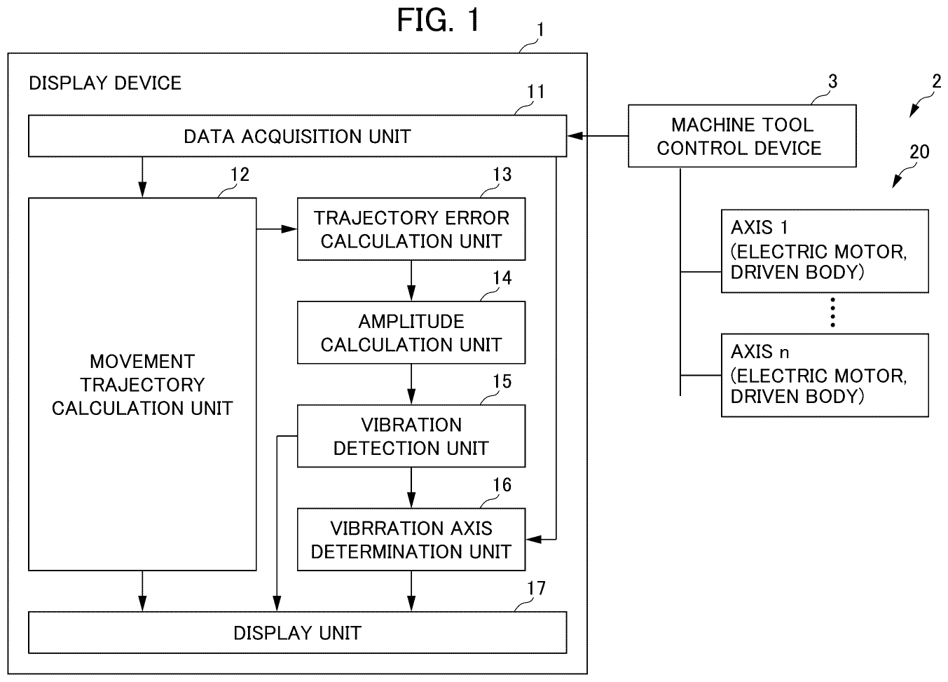

FIG. 1 shows a configuration of a display device 1 according to an embodiment of the present disclosure. As shown in FIG. 1, the display device 1 according to the present embodiment acquires servo data of a machine tool control device (servo control device) 3 for controlling electric motors (servo motors) for driving axes 20 that are axes 1 to n of a machine tool 2, performs necessary data processing, and displays the data processing results.

The machine tool control device 3 as a servo control device includes a control unit composed of a microcomputer or the like, a storage unit including a memory such as a ROM or a RAM, and a transmission/reception unit that transmits/receives servo data or the like to/from the display device 1. These units are not shown.

The display device 1 according to the present embodiment includes, for example, a computer including a CPU, a memory, and the like. As shown in FIG. 1, the display device 1 includes a data acquisition unit 11, a movement trajectory calculation unit 12, a trajectory error calculation unit 13, an amplitude calculation unit 14, a vibration detection unit 15, a vibration axis determination unit 16, and a display unit 17.

The data acquisition unit 11 acquires time series data of an actual position and a command position of the electric motor or the driven body. Specifically, the data acquisition unit 11 acquires time series data of a command position of the electric motor or the driven body from a position command generated based on a machining program. Furthermore, the data acquisition unit 11 acquires the time series data of the actual position of the electric motor or the driven body from position feedback by a position detector such as an encoder provided in the electric motor for driving the axis 20. The position feedback is acquired by dry run machining by the machine tool 2. In other words, in the present embodiment, the servo data is acquired in advance from the machine tool control device 3 by dry run machining without actually performing machining. Furthermore, the data acquisition unit 11 acquires tool information such as tool length and tool diameter, torque commands, and the like from the machine tool control device 3.

The movement trajectory calculation unit 12 calculates a movement trajectory of the tip of a tool included in the machine tool 2, i.e., a machining trajectory. Specifically, the movement trajectory calculation unit 12 calculates a movement trajectory of the tip of a tool based on the actual position from the time series data of the actual position of the electric motor or the driven body acquired by the data acquisition unit 11. Furthermore, the movement trajectory calculation unit 12 calculates a movement trajectory of the tip of the tool based on the command position from the time series data of the command position of the electric motor or the driven body acquired by the data acquisition unit 11. For calculation of each movement trajectory, the tool information acquired by the data acquisition unit 11 is also used.

The trajectory error calculation unit 13 calculates time series data of a trajectory error of the tool included in the machine tool 2. Specifically, the trajectory error calculation unit 13 calculates time series data of a trajectory error of the tool from the difference between the movement trajectory of the tool based on the actual position calculated by the movement trajectory calculation unit 12 and the movement trajectory of the tool based on the command position calculated by the movement trajectory calculation unit 12.

The amplitude calculation unit 14 calculates the amplitude of each of frequency components by performing frequency analysis of the time series data of the trajectory error of the tool calculated by the trajectory error calculation unit 13. The method of frequency analysis is not limited, and it is sufficient to analyze how much amplitude of waveforms of the frequency components are included with respect to the time series data. For example, in the present embodiment, Fourier transform is employed as a method of frequency analysis.

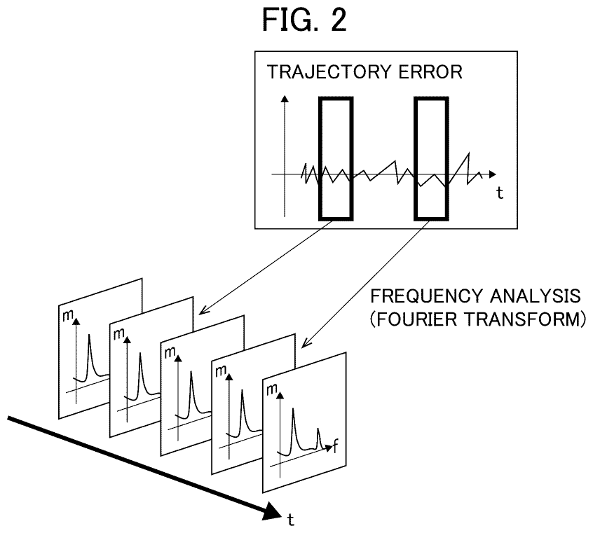

FIG. 2 illustrates frequency analysis of the time series data of the trajectory error of the tool. As shown in FIG. 2, the time series data of the trajectory error of the tool calculated by the trajectory error calculation unit 13 is converted into frequency series data by Fourier transform. That is, time series data in which the horizontal axis represents time t is converted into frequency series data in which the horizontal axis represents frequency f. This allows amplitude m of each frequency component to be calculated.

The vibration detection unit 15 detects, from among the frequency components, a frequency component having an amplitude calculated by the amplitude calculation unit 14 that is greater than a predetermined threshold, and detects, as a vibration location, a position determined from a time corresponding to the detected frequency component. The predetermined threshold is set in advance and stored from the relationship between the amplitude of each frequency component and the machining surface shape at the time and position corresponding to each frequency component, for example, based on experimental data or the like.

The vibration axis determination unit 16 determines a vibration axis that causes vibration from among the axes 20 at the vibration location detected by the vibration detection unit 15. The number of the vibration axes is not limited to one, and a plurality of axes may be determined as vibration axes. Specifically, the vibration axis determination unit 16 extracts a time range corresponding to the frequency component detected by the vibration detection unit 15, and performs frequency analysis of the time series data of the position deviation or torque command of each of the axes in the extracted time range. The vibration axis determination unit 16 determines, as a vibration axis, an axis having a frequency component having a great amplitude, the frequency component having the great amplitude being identical to the frequency component detected by the vibration detection unit 15.

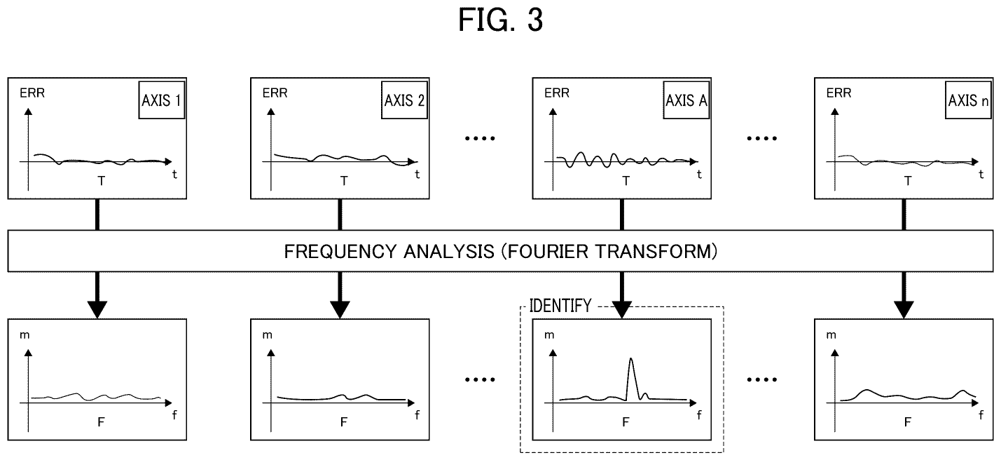

FIG. 3 illustrates frequency analysis of time series data of position deviations of the axes 20. Similarly to the frequency analysis performed by the amplitude calculation unit 14, the method of the frequency analysis is not limited, and for example, Fourier transform is employed. As shown in FIG. 3, by performing Fourier transform on the time series data of the position deviation that is the difference between the command position and the position feedback as described above, the time series data of the position deviation is converted into frequency series data. That is, time series data in which the horizontal axis represents time t is converted into frequency series data in which the horizontal axis represents frequency f. This is also the case for the time series data of the torque command generated based on the position deviation.

In FIG. 3, the data shown in the upper part is the time series data of the position deviations of the axes before the frequency analysis, and the data shown in the lower part is the frequency series data of the position deviations of the axes after the frequency analysis. In the example shown in FIG. 3, a time range T corresponding to a frequency component F detected by the vibration detection unit 15 is extracted, and the time series data of the position deviations of the axes 20 that are axes 1 to n in the time range T is subjected to frequency analysis. In this way, by performing Fourier transform on only the time range T corresponding to the frequency component F detected as the vibration location, the number of calculations can be reduced.

As shown in FIG. 3, when the frequency series data of the position deviations of the axes 20 after the Fourier transform is compared, a great peak is observed in the frequency series data of the axis A, and it is confirmed that the amplitude m thereof is great. Thus, it can be determined that the axis A is a vibration axis that is a dominant factor of vibration at the vibration location.

The display unit 17 displays the movement trajectory of the tip of the tool based on the actual position calculated by the movement trajectory calculation unit 12. Furthermore, the display unit 17 displays the vibration location detected by the vibration detection unit 15 on the movement trajectory, and displays the axis determined as the vibration axis by the vibration axis determination unit 16.

In addition, the display unit 17 can display the vibration location on the movement trajectory with a different display attribute than the other locations. Thus, the display unit 17 can highlight the vibration location, and the vibration location can be visually recognized.

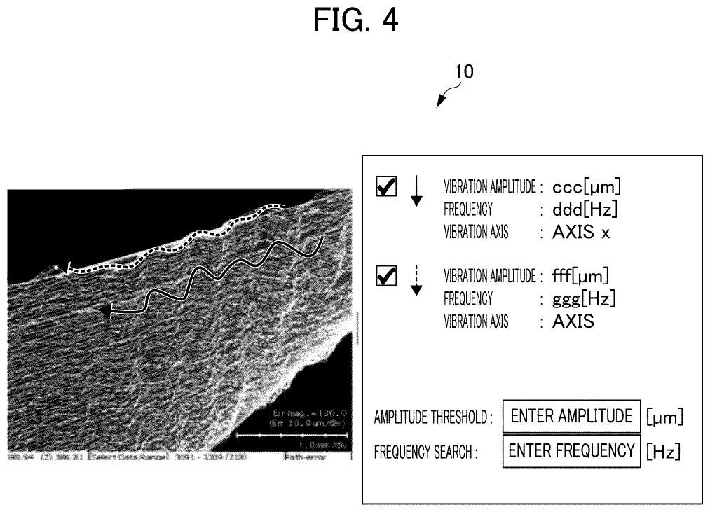

FIG. 4 shows a display example of the display device 1 according to the present embodiment. In the example shown in FIG. 4, the vibration waveforms at the vibration location are highlighted by a solid arrow or a broken arrow on the movement trajectory of the tip of the tool displayed on a display screen 10 by the display unit 17. On the display screen 10, in addition to vibration axes, text data such as frequencies and amplitudes (maximum amplitudes or the like) corresponding to the vibration axes is also displayed. Furthermore, on the display screen 10, the amplitude threshold used by the vibration detection unit 15 can be entered. Moreover, frequency search can be performed on the display screen 10 by entering a frequency, and a movement trajectory corresponding to the entered frequency can be displayed.

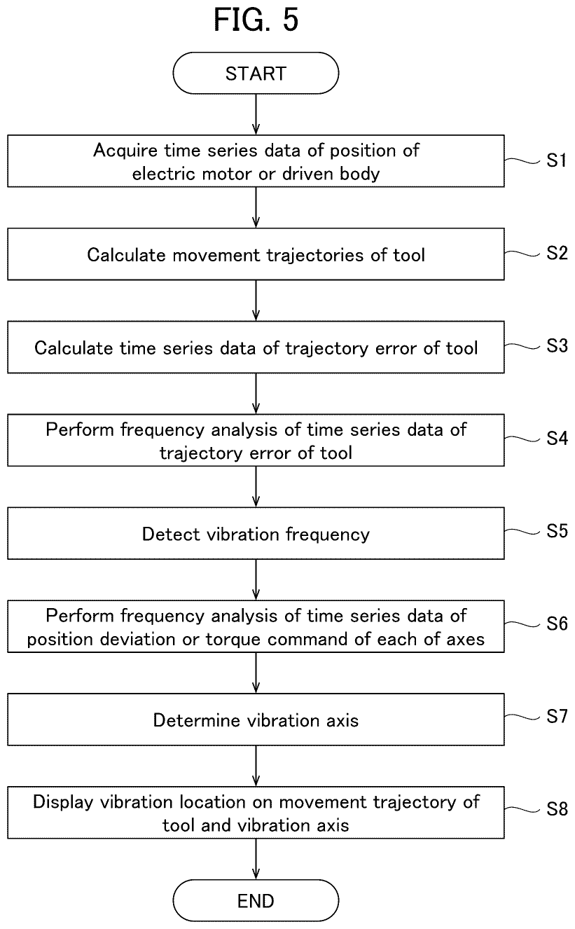

A procedure of display processing of the display device 1 according to the present embodiment having the above-described configuration will be described with reference to FIG. 5. FIG. 5 is a flowchart showing a procedure of display processing by the display device 1 according to the present embodiment. This display processing is started at an arbitrary timing after the machine tool 2 performs dry run machining.

First, in Step S1, the data acquisition unit 11 acquires time series data of a position of the electric motor or the driven body. Specifically, the data acquisition unit 11 acquires time series data of an actual position of the electric motor or the driven body and time series data of a command position of the electric motor or the driven body. Thereafter, the processing advances to Step S2.

In Step S2, the movement trajectory calculation unit 12 calculates a movement trajectory of the tip of the tool included in the machine tool 2. Specifically, the movement trajectory calculation unit 12 respectively calculates a movement trajectory based on the actual position and a movement trajectory based on the command position from the time series data of the actual position and the time series data of the command position of the electric motor or the driven body. Thereafter, the processing advances to Step S3.

In Step S3, the trajectory error calculation unit 13 calculates time series data of a trajectory error of the tool. Specifically, the trajectory error calculation unit 13 calculates time series data of a trajectory error of the tool from the difference between the movement trajectory based on the actual position and the movement trajectory based on the command position. Thereafter, the processing advances to Step S4.

In Step S4, the amplitude calculation unit 14 performs frequency analysis of the time series data of the trajectory error of the tool, and calculates the amplitudes of frequency components. Thereafter, the processing advances to Step S5. In Step S5, the vibration detection unit 15 detects a vibration frequency. Specifically, the vibration detection unit 15 detects, from among the frequency components, a frequency component having an amplitude greater than a predetermined threshold as a vibration frequency, and detects, as a vibration location, a position determined from a time corresponding to the detected frequency component. Thereafter, the processing advances to Step S6.

In Step S6, the vibration axis determination unit 16 performs frequency analysis of time series data of a position deviation or a torque command of each axis. More specifically, the vibration axis determination unit 16 extracts a time range corresponding to the frequency component detected by the vibration detection unit 15, and in the extracted time range, performs frequency analysis of time series data of a position deviation or a torque command of each axis. Thereafter, the processing advances to Step S7.

In Step S7, the vibration axis determination unit 16 determines a vibration axis that causes vibration at the vibration location. Specifically, the vibration axis determination unit 16 determines, as a vibration axis, an axis having a frequency component having a great amplitude, the frequency component having the great amplitude being identical to the frequency component detected by the vibration detection unit 15. Thereafter, the processing advances to Step S8.

In Step S8, the display unit 17 displays the vibration location on the movement trajectory of the tool and the vibration axis. Specifically, the display unit 17 displays the movement trajectory of the tip of the tool based on the actual position, and displays the vibration location detected by the vibration detection unit 15 on the movement trajectory. Furthermore, the display unit 17 displays the axis determined as the vibration axis by the vibration axis determination unit 16. The display of the vibration location on the movement trajectory is highlighted by changing the display attribute. Thereafter, the processing is terminated.

According to the present embodiment, the following effects are achieved. A display device 1 according to the present embodiment includes a trajectory error calculation unit 13 that calculates time-series data of a trajectory error of a tool from a movement trajectory of the tool based on an actual position and a movement trajectory of the tool based on a command position, an amplitude calculation unit 14 that performs frequency analysis of the time-series data of the trajectory error of the tool, and calculates amplitudes of frequency components, a vibration detection unit 15 that detects, from among the frequency components, a frequency component having an amplitude greater than a predetermined threshold, and detects a position corresponding to the detected frequency component as a vibration location, a vibration axis determination unit 16 that performs frequency analysis of time series data of a position deviation or a torque command of each of axes in a time range corresponding to the detected frequency component, and determines, as a vibration axis, an axis having a frequency component having a great amplitude, the frequency component having the great amplitude being identical to the detected frequency component, and a display unit 17 that displays the detected vibration location on the movement trajectory and displays the axis determined as the vibration axis.

When a defect occurs on a machined surface due to the vibration of the tool during machining, the vibration frequency at the defective location is important information when the cause of the defect is investigated. Therefore, in the present embodiment, by providing the above-described features, based on servo data acquired by dry run machining without actually performing machining, time series data of the amplitude of each of frequency components is calculated from time series data of a trajectory error of the tool, and a location where the vibration is great and the frequency of the vibration are automatically detected. Thus, it is possible to automatically detect a location where a machining surface defect occurs and its vibration frequency in advance, and it is possible to efficiently perform adjustment. Furthermore, it is possible to identify an axis that causes vibration by comparing the frequency component of the trajectory error at the location where vibration is great to the frequency component of the position data or the torque command of each of the axes. Furthermore, by displaying the vibration location and the vibration axis together with the movement trajectory, the user can intuitively recognize them, and the time efficiency of start-up and evaluation of industrial machines can be greatly improved.

In the present embodiment, the vibration location on the movement trajectory is highlighted by changing the display attribute. This makes it easier for the user to visually recognize, and the above-described effects are more reliably exhibited.

It should be noted that the present disclosure is not limited to the above-described embodiment, and modifications and improvements are included in the present disclosure to the extent that the object of the present disclosure can be achieved.

For example, in the above-described embodiment, the display device of the present disclosure is applied to a display device for displaying servo data of a machine tool control device, but the present disclosure is not limited thereto. The display device of the present disclosure may be applied to a display device for displaying servo data of a control device of another industrial machine such as a robot.

### EXPLANATION OF REFERENCE NUMERALS

1 display device
2 machine tool (industrial machine)
3 machine tool control device (servo control device)
10 display screen
11 data acquisition unit (acquisition unit)
12 movement trajectory calculation unit
13 trajectory error calculation unit
14 amplitude calculation unit
15 vibration detection unit
16 vibration axis determination unit
17 display unit
20 axis

1. A display device for displaying servo data of a servo control device for controlling servo motors for driving axes of an industrial machine, the display device comprising:
an acquisition unit configured to acquire time series data of an actual position and time series data of a command position of each of the servo motors or driven bodies;
a movement trajectory calculation unit configured to calculate a movement trajectory of a tool based on the actual position and a movement trajectory of the tool based on the command position from the time series data of the actual position and the time series data of the command position of each of the servo motors or the driven bodies acquired by the acquisition unit;
a trajectory error calculation unit configured to calculate time-series data of a trajectory error of the tool from the movement trajectory of the tool based on the actual position and the movement trajectory of the tool based on the command position calculated by the movement trajectory calculation unit;
an amplitude calculation unit configured to perform frequency analysis of the time-series data of the trajectory error of the tool calculated by the trajectory error calculation unit, and calculate amplitudes of frequency components;
a vibration detection unit configured to detect, from among the frequency components, a frequency component having an amplitude calculated by the amplitude calculation unit that is greater than a predetermined threshold, and detect a position corresponding to the detected frequency component as a vibration location;
a vibration axis determination unit configured to extract a time range corresponding to the frequency component detected by the vibration detection unit, in the extracted time range, perform frequency analysis of time series data of a position deviation or a torque command of each of the axes, and determine, as a vibration axis, an axis having a frequency component having a great amplitude, the frequency component having the great amplitude being identical to the frequency component detected by the vibration detection unit; and
a display unit configured to display the movement trajectory calculated by the movement trajectory calculation unit, display the vibration location detected by the vibration detection unit on the movement trajectory, and display the axis determined as the vibration axis by the vibration axis determination unit.

2. The display device according to claim 1, wherein the display unit is configured to display the vibration location on the movement trajectory with a different display attribute.
